(19) United States
(12) Patent Application Publication
(10) Pub. No.: US 2020/0340809 A1
(43) Pub. Date: Oct. 29, 2020

(54) PRESSURE SENSING SWITCH STRUCTURE OF RANGE FINDER

(71) Applicant: TUNG SHRIM ENTERPRISE CO., LTD., Taichung City (TW)

(72) Inventor: WEN-I CHANG, Taichung City (TW)

(21) Appl. No.: 16/391,324

(22) Filed: Apr. 23, 2019

(51) Int. Cl. G01C 3/08; G01C 3/14

(52) U.S. Cl. CPC G01C 3/08; G01L 2019/0053; G01C 3/14

(57) ABSTRACT

A pressure sensing switch structure of a range finder, including: a first housing, a distance sensing unit configured inside the first housing, one end of the first housing configured with a front lens and detecting window, the distance sensing unit corresponding to the detecting window, and at least one side of the first housing configured with at least one pressure sensor in electric connection with the distance sensing unit; and a second housing, two end thereof respectively configured with a display and rear lens, the display connected electrically with the distance sensing unit, one end of the display of the second housing combined with another end of the first housing, allowing the front lens to correspond to the rear lens, thereby pressing the pressure sensor to allow the distance sensing unit to transmit at least one distance value to the display after detection scanning of the distance sensing unit.

### (a) TECHNICAL FIELD OF THE INVENTION

The present invention relates to a range finding device, and more particularly to a range finder with a pressure sensor.

### (b) DESCRIPTION OF THE PRIOR ART

The rules of golf are mainly for the players to enter the target (i.e. green) hole from the tee shot with the least number of shots, and the two basic elements that exist between the teeing ground and the target hole are “distance” and “angle” (of course, there are other factors such as wind speed and turf direction, no remarks here). In a golf tournament, in addition to controlling the direction of the ball with contestants' swing skills, the most important thing is that the distance of the target ground must be accurately measured by contestants' experience in order to control the distance of the hitting distance. For beginners in golf, if they want to penetrate skills, the most important thing is that they must learn how to accurately measure the distance between the target location and the location where they are now besides must constantly practice the swing to improve the ball control skills and swing force.

Conventional distance measuring devices have disadvantages as the following: they only can detect the distance of a single target; to users, fractional measurements are needed if the distances of other targets want to be detected, and the fractional measurements needs to use paper and pen to record the distance value of each target.

### SUMMARY OF THE INVENTION

To overcome the above disadvantages, the present invention proposes a pressure sensing switch structure of a range finder, including: a first housing, a distance sensing unit configured inside the first housing, one end of the first housing configured with a front lens and detecting window positioned below the front lens, the distance sensing unit corresponding to the detecting window, and at least one side of the first housing configured with at least one pressure sensor in electric connection with the distance sensing unit; and a second housing, two end thereof respectively configured with a display and rear lens, the display in electric connection with the distance sensing unit, one end of the display of the second housing in combination with an inside of another end of the first housing, allowing the front lens to correspond to the rear lens, thereby pressing the pressure sensor to allow the distance sensing unit to transmit at least one distance value to the display after detection scanning of the distance sensing unit.

According to the structure mentioned above, the structure according to claim 1, wherein a pad is configured on an outside of the pressure sensor.

According to the structure mentioned above, the pressure sensor has a short press mode and long press mode, thereby respectively activating the distance sensing unit.

According to the structure mentioned above, the distance sensing unit comprises a plurality of first sensors, a plurality of second sensor, an arithmetic processor and a memory, each of the first sensors and each of the second sensors are adapted to respectively reciprocally scan at least one first target and a plurality of second targets from top to bottom and from left to right, and the arithmetic processor calculates distances between the first target and the range finder and between each of the second targets and the range finder and respectively displays the distance values of the first target and each of the second targets on the display, and at the same time, stores the distance vales of the first target and each of the second targets in the memory, with the distance between the first target and each of the second targets displayed in sequence from near to far.

According to the structure mentioned above, each of the first sensors and each of the second sensors respectively are a multi-axis sensor.

According to the structure mentioned above, a front sight is further displayed on the display, the front sight is adapted to aim at the first target, and the distance value of the first target is adjacent to the front sight.

According to the structure mentioned above, the distance value of each of the second targets are positioned outside the front sight and the distance value of the first target.

According to the structure mentioned above, a secondary distance value is further displayed below said distance value of each of said second targets, and said secondary distance value is a distance value between said first target and each of said second targets.

### BRIEF DESCRIPTION OF THE DRAWINGS

FIG. 1 is a structural block diagram of the present invention;

FIG. 2 is a perspective view of the present invention;

FIGS. 3 and 4 respectively are a perspective view of the present invention, where a pressure sensor is shown;

FIG. 5 is a structural block diagram of a distance sensing unit of the present invention;

FIG. 6 is a schematic view of a first target and second targets of the present invention;

FIG. 7 is a schematic view of distance values according to the present invention; and

FIG. 8 is a schematic view of distance values of another mode according to the present invention.

### DETAILED DESCRIPTION OF THE PREFERRED EMBODIMENTS

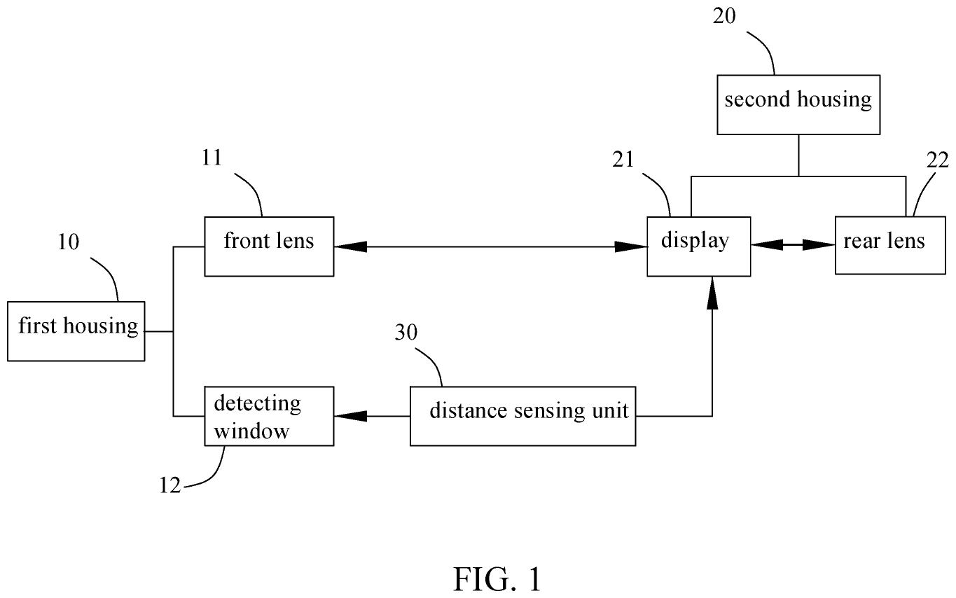

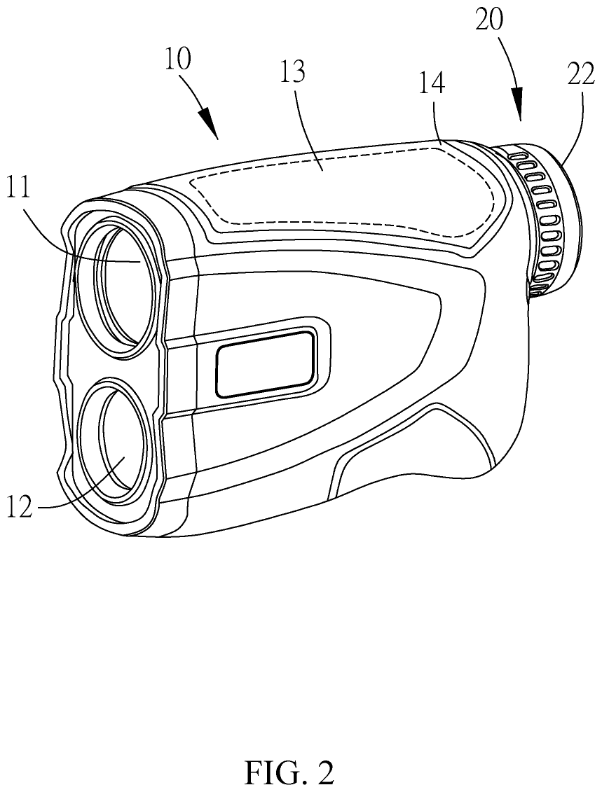

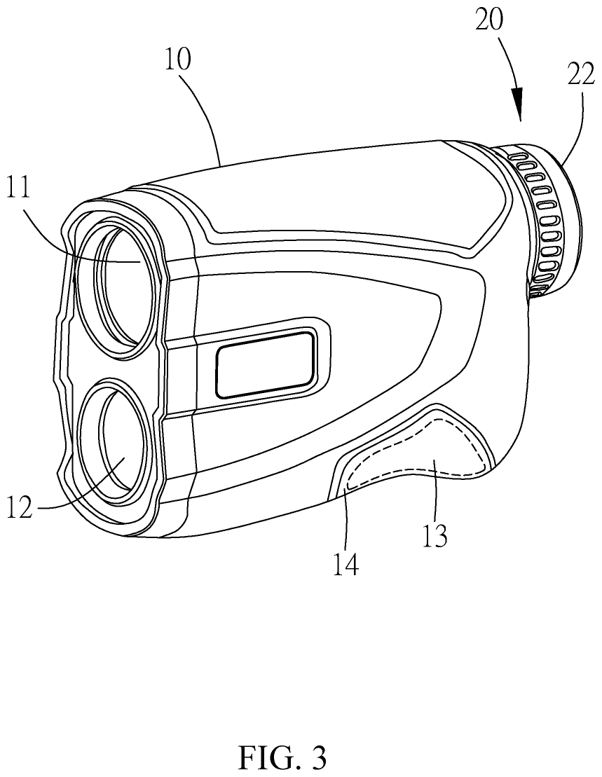

Referring to FIGS. 1 to 3, a pressure sensing switch structure of a range finder includes a first housing 10 and second housing 20.

A distance sensing unit 30 is configured inside the first housing 10, and one end of the first housing 10 is configured with a front lens 11 and a detecting window 12 located below the front lens 11, where the distance sensing unit 30 corresponds to the detecting window 12, and at least one side of the first housing is configured with a pressure sensor 13; a pad 14 is configured on the pressure sensor 13, and the pressure sensor 13 is in electric connection with the distance sensing unit 30.

A display 21 and rear lens 22 both in electric connection with the distance sensing unit 30 are configured on the two respective ends of the second housing 22, and the end of the second housing 20 configured with the display 21 is in combination with the inside of another end of the first housing 10, allowing the front lens 11 and rear lens 22 to correspond to each other; at least one distance value 51 is transmitted to the display 21 after the pressure sensor 13 is pressed to activate the detection of the distance sensing unit 30.

The pressure sensor 13 further has a short press mode and long press mode to activate the distance sensing unit 30 respectively, but the present invention is not so limited. The long press mode can also be set to activate the multi-target scanning of the distance sensing unit 30.

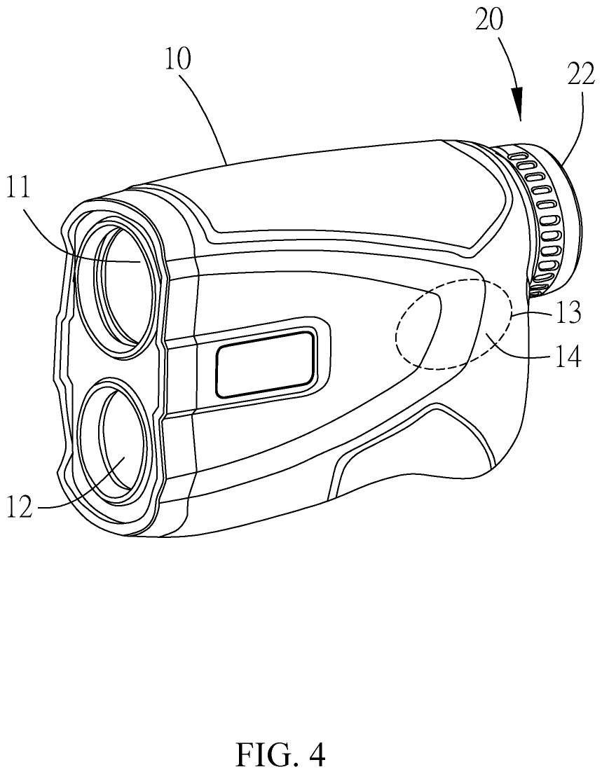

Referring to FIG. 4, the distance sensing unit 30 is configured inside the first housing 10 and in electric connection with the display 21; the distance sensing unit 30 includes a plurality of first sensors 31, a plurality of second sensors 32, an arithmetic processor 33 and a memory 34, where each first sensor 31 and each second sensor 32 respectively are a multi-axis sensor.

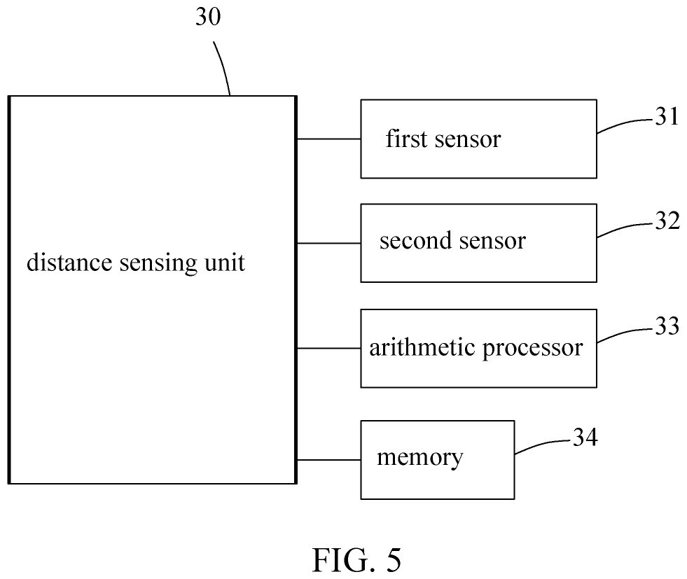

In use, the distance sensing unit 30 of the pressure sensing switch structure of a range finder of the present invention, as FIGS. 1, 4 to 7 show, watches a first target 50 and each of the second targets 60 through the front lens 11 and rear lens 22. In the embodiment, the first target 50 is a flagpole, and each of the second targets 60 is woods behind or around the flagpole 50. Furthermore, the display 21 is displayed with a front sight 211 adapted to aim at the first target; the at least one first target 50 and the plurality of second targets 60 are respectively reciprocally scanned from top to bottom, from left to right by each first sensor 31 and each second 32.

Furthermore, the distances between the first target 50 and the range finder and between each of the second targets 60 and the range finder are respectively calculated by the arithmetic processor 33, and the distance value 51 of the first target 50 and the distance value 61 of each of the second targets 60 are respectively displayed on the display 21; the distance value of the first target 50 is adjacent to the front sight 211.

At the same time, the distance value 51 of the first target 50 and the distance value 61 of each of the second targets 60 are stored in the memory 34, thereby allowing users not to repeat scanning detection and capable of re-viewing the previously detected distance value 51, 61.

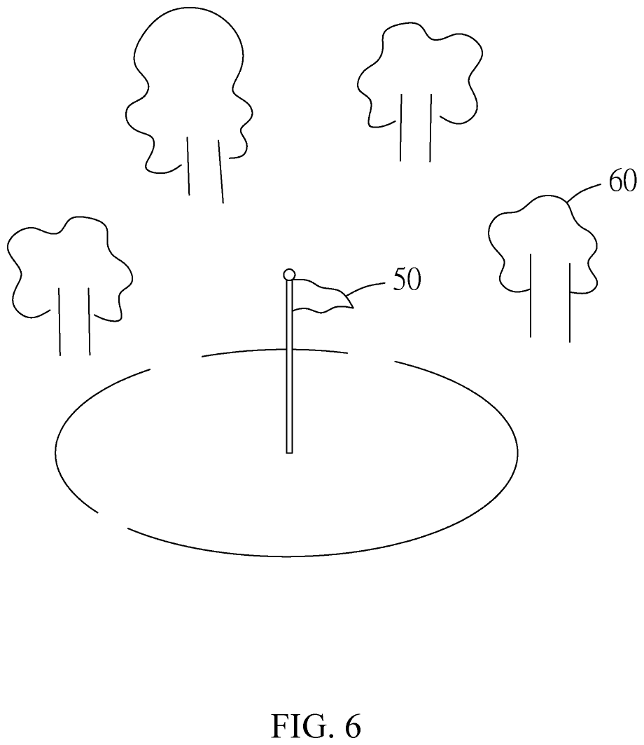

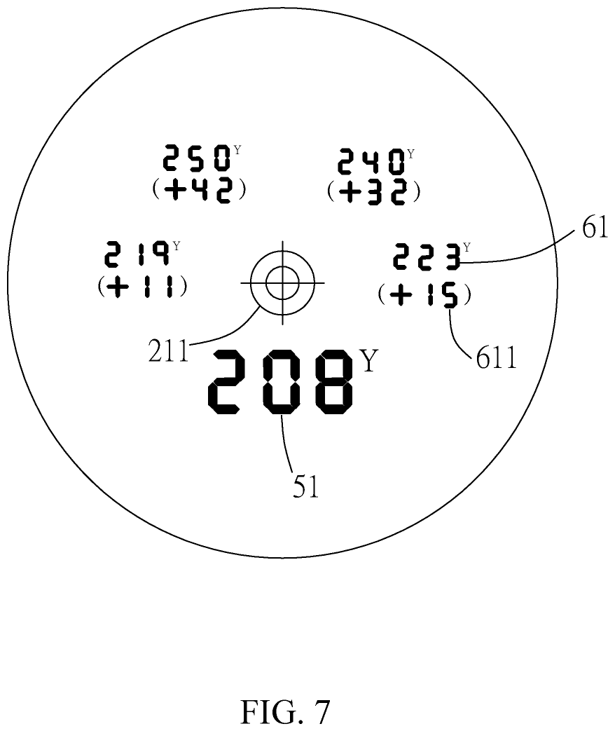

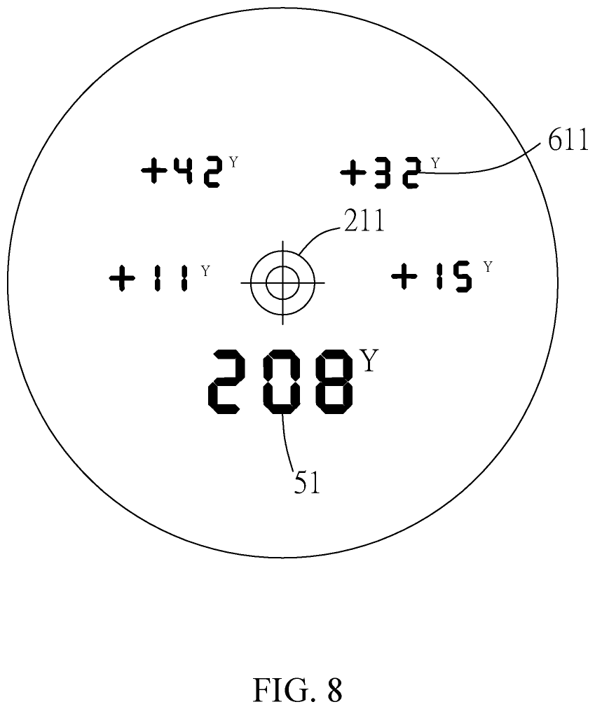

In addition, the distances between the first target 50 and each of the second targets 60 are displayed in sequence from near to far. In short, the distance sensing unit 40 will only show the distance value 61 of each of the second targets 60 closest to the first target 50 after the scanning and calculation. Referring to FIGS. 6 and 7, the second targets 60, in the embodiment, number 4, where the distance value 61 of each of the second targets 60 is positioned outside the front sight 211 and the distance value of the first target 50 and consistent with the position of each of the second targets 60.

With the arithmetic function of the arithmetic processor 33, a secondary distance value 611 is further displayed below the distance value 61 of each of the second targets 60, where the secondary distance value 611 is a distance between the first target 50 and each of the second targets 60.

Furthermore, users can also change the settings: allowing the display 21 only to display the distance value 51 of the first target 50 and the secondary distance value 611 of each of the second targets 60 in order to better match the user's habit of reading observation values.

I claim:

1. A pressure sensing switch structure of a range finder, comprising:
a first housing, a distance sensing unit configured inside said first housing, one end of said first housing configured with a front lens and detecting window positioned below said front lens, said distance sensing unit corresponding to said detecting window, and at least one side of said first housing configured with at least one pressure sensor in electric connection with said distance sensing unit; and
a second housing, two end thereof respectively configured with a display and rear lens, said display in electric connection with said distance sensing unit, one end of said display of said second housing in combination with an inside of another end of said first housing, allowing said front lens to correspond to said rear lens, thereby pressing said pressure sensor to allow said distance sensing unit to transmit at least one distance value to said display after detection scanning of said distance sensing unit.

2. The structure according to claim 1, wherein a pad is configured on an outside of said pressure sensor.

3. The structure according to claim 2, wherein said pressure sensor has a short press mode and long press mode, thereby respectively activating said distance sensing unit.

4. The structure according to claim 1, wherein said distance sensing unit comprises a plurality of first sensors, a plurality of second sensor, an arithmetic processor and a memory, each of said first sensors and each of said second sensors are adapted to respectively reciprocally scan at least one first target and a plurality of second targets from top to bottom and from left to right, and said arithmetic processor calculates distances between said first target and said range finder and between each of said second targets and said range finder and respectively displays said distance values of said first target and each of said second targets on said display, and at the same time, stores said distance vales of said first target and each of said second targets in said memory, with said distance between said first target and each of said second targets displayed in sequence from near to far.

5. The structure according to claim 4, wherein each of said first sensors and each of said second sensors respectively are a multi-axis sensor.

6. The structure according to claim 1, wherein a front sight is further displayed on said display, said front sight is adapted to aim at said first target, and said distance value of said first target is adjacent to said front sight.

7. The structure according to claim 6, wherein said distance value of each of said second targets are positioned outside said front sight and said distance value of said first target.

8. The structure according to claim 7, wherein a secondary distance value is further displayed below said distance value of each of said second targets, and said secondary distance value is a distance value between said first target and each of said second targets.
